(19) United States
(12) Patent Application Publication
(10) Pub. No.: US 2010/0001829 A1
(43) Pub. Date: Jan. 7, 2010

(54) Anti-vehicle theft identification system

(76) Inventor: Neng-Wei Chang, Linkou Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/216,265

(22) Filed: Jul. 2, 2008

(51) Int. Cl. B60R 25/10

(52) U.S. Cl. 340/5.32

(57) ABSTRACT

The present invention discloses an anti-vehicle theft identification system, which comprises an input device and at least one identification system. The input device is used to read data from a card, and the identification system is installed on a vehicle body. The identification system further comprises a memory unit, an identification unit, a control unit and a light emitting component. The memory unit stores data for comparison and identification. The identification unit compares the data read by the input device with the data stored in the memory unit to determine whether the two pieces of data coincide. If the two pieces of data coincide, the identification unit triggers the control unit to turn on the light emitting component. The light emitting component is arranged on an easy-to-see area of the vehicle body and lightens when the identification passes, whereby the status of the vehicle can be easily recognized, and everyone can learn at a glance whether a vehicle is in legal usage or a possible stolen vehicle. Therefore, an anti-vehicle theft identification system increases the vehicle identification rate and reduces the vehicle theft rates.

### BACKGROUND OF THE INVENTION

1. Field of the Invention

The present invention relates to an anti-vehicle theft identification system, which applies to cars, trucks, motorcycles and other vehicles to reduce the theft rate, wherein an identification system installed in a vehicle receives data from an input device and performs identification to determine whether to turn on an identification sign, whereby the status of the vehicle can be easily recognized from the appearance.

2. Description of the Related Art

In the past ten-odd years of economic growth and technology development, people has rapidly accumulated wealth, and transports also have been gradually upgraded from motorcycles to automobiles. Many families even own more than one automobile in recent years. Automobiles are expensive, and each costs from five or six hundred thousand to over one million or even ten million New Taiwan Dollars. Most of the people have to work and save for several years to buy an automobile. Thus, thieves have motive to steal automobiles and profit therefrom. The owners should be rankled by automobile thefts badly. Further, stolen automobiles are often used as criminal tools. The vehicle theft rate has stood high for many years. Vehicle theft prevention programs are always scheduled into the high-priority tasks of the police, and much police manpower is spent thereon. However, the effort thereof is usually unclear.

Many technologies were developed to prevent from vehicle theft, such as two-stage locks, electronic locks, and cane locks. In the past few years, some high-tech manufacturers have developed fingerprint recognition locks to increase the difficulty of stealing a vehicle. At present, high-tech locks can prolong the process of stealing a vehicle to win the time for reporting the police and awaiting police arrival. However, thieves would learn to break high-tech locks eventually. From statistics, a thief uses only 10-30 seconds on average to break a vehicle lock. When the police force arrives, the vehicle has disappeared for a long time, and the police can only inform police stations everywhere to notice and search for stolen vehicles, wherefore the police consume so much manpower but only earn a reputation of being inefficient and effortless. It is thus also known that the prior arts cannot effectively prevent vehicle theft.

Accordingly, the Inventor devoted himself to design an apparatus having an input device and an identification system to solve the abovementioned problems and effectively prevent from vehicle theft.

### SUMMARY OF THE INVENTION

The primary objective of the present invention is to provide an anti-vehicle theft identification system, wherein an identification sign is installed on the easy-to-see areas of a vehicle, and the light emitting component thereof lighten or darken to indicate the status of the vehicle, whereby the status of a vehicle can be easily recognized, and the efficiency of the police is promoted, and whereby all the people can take part in maintaining public security.

Another objective of the present invention is to provide an anti-vehicle theft identification system, wherein an identification system is connected with an input system to determine whether input data is valid, whereby the vehicle theft rate can be reduced, and whereby criminal usage of a stolen vehicle, such as robbery, can be prevented.

A further objective of the present invention is to provide an anti-vehicle theft identification system, which has a chip card to store the personal data of the vehicle owner, the data on the vehicle license and the status of vehicle usage, whereby the police can read the data inside the chip card to ticket the driver and then link to the motor vehicle office to upload the traffic violation case, and whereby traffic safety is promoted and traffic accidents are decreased.

To achieve the abovementioned objectives, the present invention proposes an anti-vehicle theft identification system, which comprises an input device and at least one identification system, wherein the input device is used to read the data inside a card, and the identification system is installed on a vehicle body. The identification system further comprises a memory unit, an identification unit, a control unit and a light emitting component. The memory unit stores data for comparison and identification. The identification unit compares the data read by the input device with the data stored in the memory unit to determine whether the two pieces of data coincide. If the two pieces of data coincide, the identification unit triggers the control unit to turn on the light emitting component. The light emitting component is arranged on an easy-to-see area of the vehicle body and lightens when the identification passes, whereby the status of the vehicle can be easily recognized. The vehicle is equipped with a card reader to read the data inside a chip card having been inserted into the card reader, and then the card reader transmits the read data to the identification system; the identification system compares the read data and the data stored in the memory unit to determine whether the chip card is valid. Then, the light emitting component is turned on/off to indicate the status of the vehicle. Thereby, the status of the vehicle can be easily recognized, which can effectively save police manpower and greatly reduce the vehicle theft. Further, the idea that all the people take part in maintaining public security is thus realized.

Therefore, the system of the present invention is very hard to break and can greatly promote vehicle security.

Below, the embodiments and characteristics of the present invention are described in detail in cooperation with the attached drawings to further demonstrate the present invention.

### BRIEF DESCRIPTION OF THE INVENTION

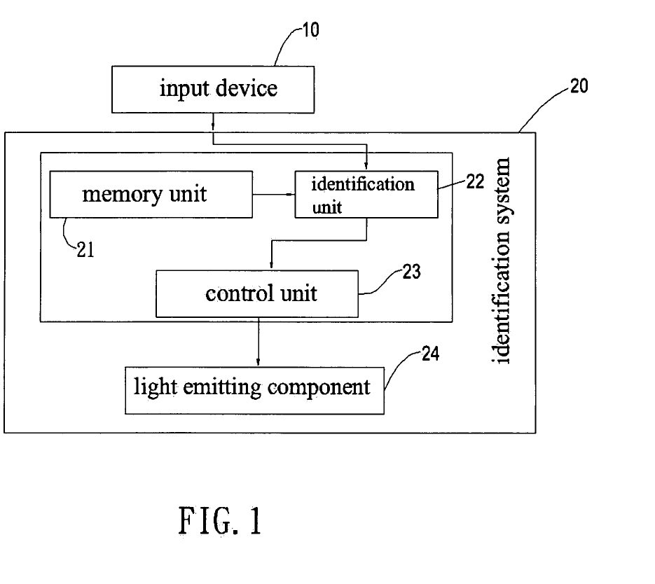

FIG. 1 is a block diagram schematically showing an anti-vehicle theft identification system according to the present invention;

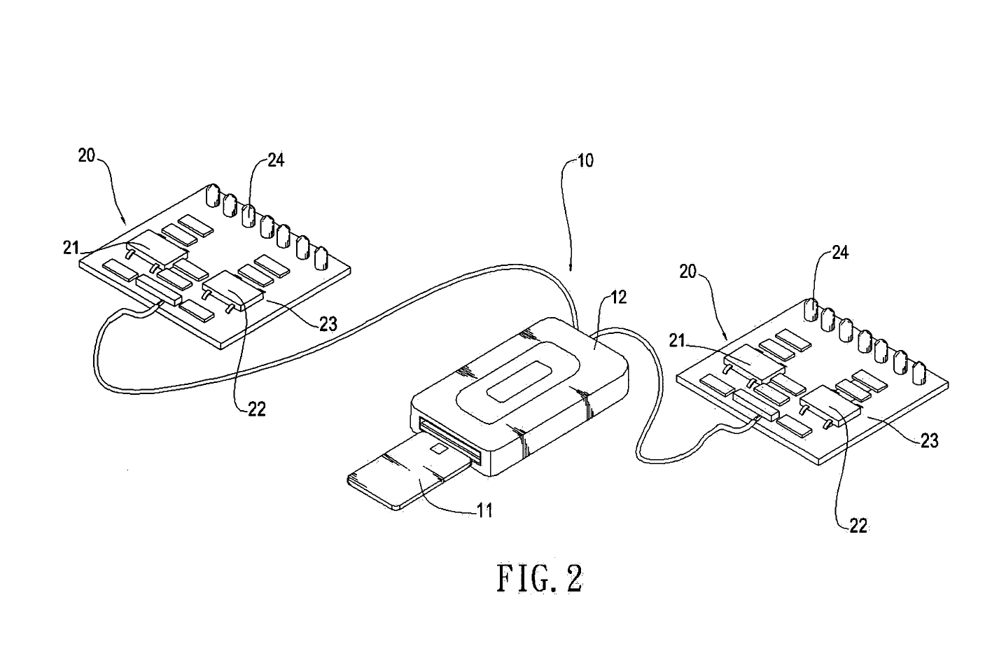

FIG. 2 is a diagram schematically showing the components of an anti-vehicle theft identification system according to the present invention; and

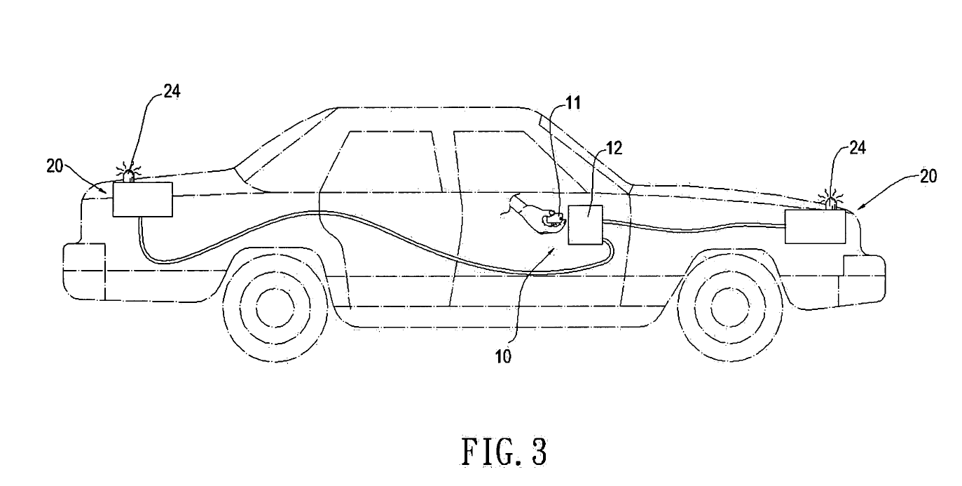

FIG. 3 is a diagram schematically showing that the present invention is installed in a vehicle.

### DETAILED DESCRIPTION OF THE INVENTION

Refer to FIG. 1 and FIG. 2. The anti-vehicle theft identification system of the present invention comprises an input device 10 and at least one identification system 20. The input device 10 further comprises a chip card 11 and a card reader 12. The chip card 11 is used to store the personal data of the vehicle owner, the data on the vehicle license and the status of vehicle usage, and the card reader 12 is used to read the data inside the chip card 11. The identification system 20 is installed in a vehicle body and further comprises a memory unit 21, an identification unit 22, a control unit 23, and a light emitting component 24. The memory unit 21 stores data for comparison and identification. The memory unit 21 contains one of the following memory devices: RAM (Random Access Memory), ROM (Read Only Memory), DRAM (Dynamic RAM), SRAM (Static RAM), PROM (Programmable ROM), EPROM (Erasable PROM), and a flash memory. The memory unit 21 has a firmware with programs burned thereon and the data of a valid chip card 11, which is to be used in identification. The identification unit 22 is an integrated circuit. The identification unit 22 receives the data that the input unit 10 reads from a chip card 11 and compares the read data with the data stored in the memory unit 21 to see whether the read data coincides with the stored data and determine whether the chip card 11 is valid. The control unit 23 has a control circuit and a switch, and the switch can turn on the light emitting component 24. If the chip card 11 is valid, the identification unit 22 transmits a signal to the control circuit of the control unit 23, and the control circuit controls the switch to turn on the light emitting component 24. The light emitting component 24 is arranged on the easy-to-see areas of a vehicle and contains electric light bulbs, LED (Light Emitting Diode), or other light emitting elements. If the identification passes, the light emitting component 24 lightens. If the identification does not pass, the light emitting component 24 will not lighten. Therefore, the status of a vehicle can be easily recognized from the appearance of the vehicle.

Refer to FIG. 2 and FIG. 3 for an anti-vehicle theft identification system according to an embodiment of the present invention. In this embodiment, a vehicle is equipped with a card reader 12, and a valid user has a chip card 11 storing the personal data of the vehicle owner, the data on the vehicle license and the status of vehicle usage; the user inserts the chip card 11 into the card reader 12; the card reader 12 reads the data inside the chip card 11 and transmits the data to two identification systems 20 respectively installed in the front and rear of the vehicle; each identification system 20 compare the input data and the data stored in the identification system 20 itself to determine whether the input data coincides with the stored data and then decide whether the chip card 11 is valid; if the chip card 11 is valid, the light emitting components 24 lighten; if the chip card 11 is invalid, the light emitting components 24 will not lighten. The identification system 20 can verify whether the usage of a vehicle is legal and determine whether the light emitting component 24 lightens. When the light emitting component 24 of a vehicle in usage is lightening, it indicates that the usage of the vehicle is normal and legal. When the light emitting component 24 of a vehicle in usage does not lighten, it indicates that the usage of the vehicle is abnormal or illegal; for example, the vehicle is a stolen one. As the light emitting component 24 is installed in the easy-to-see area of a vehicle, everyone on the street, no matter he is an old man, a child or a student, can learn at a glance whether a vehicle is in legal usage. If the state of the light emitting component 24 indicates that the usage of a vehicle is illegal (for example, it is a stolen one or in abnormal usage), spectators can inform the police immediately. Then, the police can intercept and check the vehicle. Therefore, when a thief intends to steal a vehicle having the anti-vehicle theft identification system of the present invention, he has to think about the risk that the stealth would be recognized instantly. Policemen usually spend too much time on writing tickets. In future, policemen can quickly complete ticketing merely via inserting the chip card 11 into a palmtop computer and entering the related article and paragraph into the palmtop computer. Further, the police may link the palmtop computer to the motor vehicle office to crosscheck the vehicle license data and the vehicle status stored in the chip card 11.

From the above description, it is known that the present invention has the following advantages:
1. The anti-vehicle theft identification system of the present invention has an identification system determining whether the usage of a vehicle is legal according to the data stored in a chip card. If the usage of the vehicle is illegal, the identification system will not turn on the light emitting component thereof. As the light emitting component is arranged on an easy-to-see area of a vehicle, the status of the vehicle can be recognized easily, which not only can save police manpower but also can realize the idea that all the people take part in maintaining public security.
2. In the present invention, the personal data of a vehicle owner, the data on the vehicle license and the status of vehicle usage are burned in a chip card; a card reader is used to read the data inside the chip card, and an identification system is used to crosscheck the read data and determine whether the usage of a vehicle is legal. Thus, the system of the present invention is very hard to break and can greatly promote the security of vehicles.

From the above description, it is known that the present invention can indeed achieve the aforementioned objectives and meets the conditions for a patent. Thus, the Inventor files the application for a patent.

The embodiments described are only to exemplify the present invention but not to limit the scope of the present invention. Therefore, any equivalent modification or variation according to the spirit of the present invention is to be also included within the scope of the present invention.

What is claimed is:

1. An anti-vehicle theft identification system comprising:
an input device used to read data of a card; and
at least one identification system installed on a vehicle and further comprising a memory unit, an identification unit, a control unit, and a light emitting component,
wherein said memory stores data for comparison and identification, and
wherein said identification unit compares data read from a card with data stored in said memory unit to determine whether two pieces of said data coincide, and
wherein if two pieces of said data coincide, said identification unit triggers said control unit to turn on said light emitting component arranged on an easy-to-see area of said vehicle,
whereby a status of said vehicle can be easily recognized from appearance of said vehicle, and
whereby vehicle theft rate is reduced.

2. The anti-vehicle theft identification system according to claim 1, wherein said input device further comprises a chip card and a card reader, and said card reader read data from said chip card having been inserted into said card reader.

3. The anti-vehicle theft identification system according to claim 1, wherein said memory unit contains one of following memory devices: RAM (random access memory), ROM (read only memory), DRAM (dynamic RAM), SRAM (static RAM), PROM (programmable ROM), EPROM (erasable PROM), and a flash memory.

4. The anti-vehicle theft identification system according to claim 1, wherein said memory unit has a firmware with programs burned thereon and data of a valid said chip card.

5. The anti-vehicle theft identification system according to claim 3, wherein said memory unit has a firmware with programs burned thereon and data of a valid said chip card.

6. The anti-vehicle theft identification system according to claim 1, wherein said identification unit is an integrated circuit performing comparison to determine whether data read by said input device from a card coincides with data stored in said memory unit.

7. The anti-vehicle theft identification system according to claim 1, wherein said control unit has a control circuit and a switch, and said control circuit controls said switch to turn on said light emitting component after receiving a signal from said identification unit.

8. The anti-vehicle theft identification system according to claim 1, wherein said light emitting component contains electric light bulbs.

9. The anti-vehicle theft identification system according to claim 1, wherein said light emitting component contains LEDs.
